(19) United States
(12) Patent Application Publication
(10) Pub. No.: US 2024/0125657 A1
(43) Pub. Date: Apr. 18, 2024

(54) TEMPERATURE MONITORING SYSTEM AND METHOD

(71) Applicant: Brisby, Inc., Newton, MA (US)

(72) Inventor: Jamie Gordon Nichol, Concord, MA (US)

(21) Appl. No.: 18/381,361

(22) Filed: Oct. 18, 2023

Related U.S. Application Data
(60) Provisional application No. 63/416,987, filed on Oct. 18, 2022.

(51) Int. Cl. G01K 17/00; A01K 1/015; A01K 1/035; A47C 7/74; H05B 1/02

(52) U.S. Cl. CPC G01K 17/00; A01K 1/0158; A01K 1/0353; A47C 7/748; H05B 1/0252

(57) ABSTRACT

Embodiments provide a temperature sensing device that allows measuring temperature of a subject through insulating layers such as fur or other insulating layer.

### CROSS-REFERENCE TO RELATED APPLICATION(S)

This patent application claims the benefit of United States Provisional Patent Application No. 63/416,987 entitled TEMPERATURE MONITORING SYSTEM AND METHOD filed Oct. 18, 2022, which is hereby incorporated herein by reference in its entirety.

### FIELD OF THE INVENTION

The invention generally relates to temperature monitoring such as for animal or human body temperature monitoring and other applications.

### BACKGROUND OF THE INVENTION

Body temperature sensing generally involves unimpeded access to a body surface or body cavity, e.g., taking temperature invasively (e.g., orally or rectally) or non-invasively (e.g., underarm, in-ear, forehead, etc.). However, in many situations, body cavity sensing is not possible or practical, and having unimpeded access to a body surface is not possible or practical (e.g., due to an insulator between the body surface and the temperature sensor such as animal fur, animal shell, a blanket, a bandage or cast, clothing, etc.).

Furthermore, in many situations, body temperature must be monitored over extended periods of time (e.g., during extended bouts of medical care or rehabilitation). This generally involves either maintaining a temperature sensor on the patient for an extended amount of time or a care provider having to take the temperature from time to time, both of which can increase the cost of patient care and also can be inconvenient to the patient (e.g., discomfort, repeatedly disturbing the patient to take temperature measurements, etc.).

### SUMMARY OF VARIOUS EMBODIMENTS

In accordance with one embodiment of the invention, a system for monitoring temperature of a subject includes a heat conducting layer; a heat flux sensor positioned to be between the heat conducting layer and the subject when the subject is placed directly or indirectly in contact with the heat flux sensor, the heat flux sensor configured to provide signals representative of a temperature difference between the heat conducting layer and the subject; a temperature controller to affect the temperature of the heat conducting layer; a temperature sensor to sense temperature of the heat conducting layer; and a process controller coupled to the temperature controller, the temperature sensor, and the heat flux sensor, wherein the process controller is configured to control the temperature controller based on the signals to affect the temperature of the heat conducting layer until the signals indicate that the temperature of the heat conducting layer is substantially equal to the temperature of the subject and then to determine the temperature of the heat conducting layer using the temperature sensor.

In various alternative embodiments, the heat flux sensor may include a Peltier device. The temperature controller may include a heater such as a resistor or a FET. Additionally or alternatively, the temperature controller may include a cooler. Thus, for example, the temperature controller may include a Peltier device that can alternatively heat or cool the heat conducting layer. The heat conducting layer may include a metal such as aluminum or copper. The heat conducting layer may be configured to protect against heat flowing laterally into or out from a measurement region about the heat flux sensor, e.g., configured as a bowl or ring. The heat conducting layer may include a thermal mass configured to diffuse heat gradients across the heat flux sensor.

In still other embodiments, the heat flux sensor signals may be voltage signals, current signals, or digital signals. The process controller may include a PID controller. The process controller may be configured to control the temperature of the heat conducting layer to a predetermined temperature before the subject is placed directly or indirectly in contact with the heat flux sensor, e.g., to a temperature within an expected temperature range for the subject. The subject may be placed in direct contact with the heat flux sensor, e.g., where the heat flux sensor is exposed. Alternative, the subject may be placed in indirect contact with the heat flux sensor, e.g., with the system including a heat spreader positioned to be between the subject and the heat flux sensor (e.g., a layer of padding on which the subject can rest). The system may include an insulating layer that thermally insulates at least a portion of the heat conducting layer. In some embodiments, the insulating layer may be air. The system may include a heat spreader (e.g., a cushion) positioned to be between the heat flux sensor and the subject.

In various embodiments, the any or all of the above-described components may be incorporated in a device on which the subject can rest, e.g., a pet bed or pad. Without limitation, devices may be configured to accommodate specific types of subjects such as animals or humans.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically presents a model representative of the problem to be solved.

FIG. 2 is a schematic diagram showing a body temperature monitoring system in accordance with one embodiment.

FIG. 3 is a schematic side cross-sectional view of a temperature monitoring system in accordance with one embodiment.

FIG. 4 is a schematic perspective cut-away view of the temperature monitoring system of FIG. 3.

FIG. 5 is a cross-sectional view of a rotationally symmetric arrangement of components in accordance with one alternative embodiment.

FIG. 6 shows another rotationally symmetric cross-section of an alternative embodiment in which the lower heat spreader is a thermal mass.

FIG. 7 is a schematic circuit diagram where electrical currents represent heat flows and electrical potential represents temperature for the embodiments described above.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Exemplary embodiments are discussed herein with reference to body temperature monitoring of an animal (which can include a human) such as for use during medical treatment, although it should be noted that the technologies described herein have significantly broader applicability. Some alternative applications are mentioned below, without limitation.

Generally speaking, embodiments provide a temperature sensing device that allows measuring temperature of a subject through insulating layers such as fur or other insulating layer.

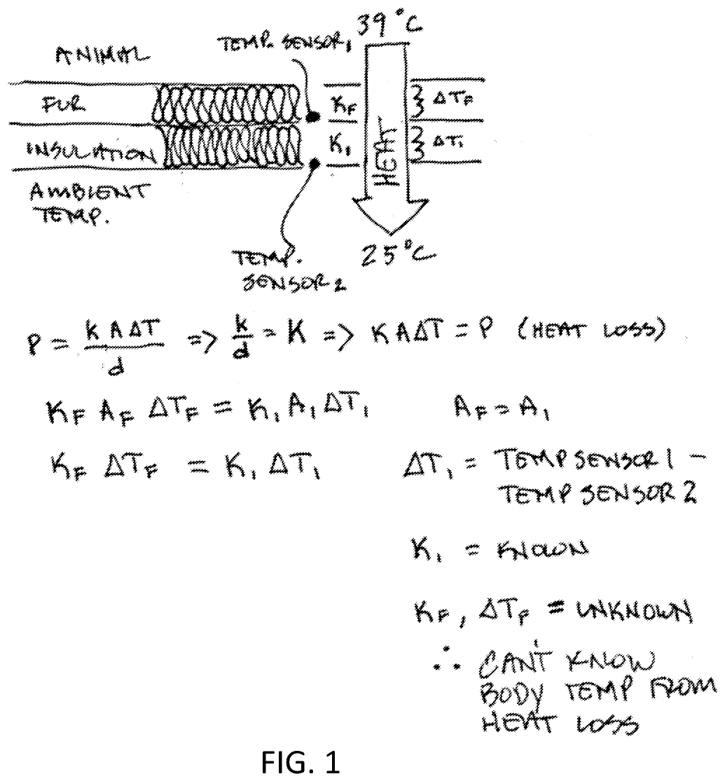

FIG. 1 schematically presents a model representative of the problem to be solved with respect to sensing body temperature of an animal. The animal has an unknown body temperature (39° C. in this example) relative to an ambient temperature (25° C. in this example), meaning that there is heat loss from the animal to the surroundings at ambient temperature. The animal is covered in an insulating layer (e.g., fur in this example, although other types of insulation might be involved such as a shell) having an unknown thermal conductivity K_{F}. The animal is placed on a surface such as a bed, which represents another layer that can have a known thermal conductivity K₁. Temperature sensors can be placed as shown to measure temperatures, e.g., at the interface between the fur and the surface and at the interface between the surface and the ambient. Just as K_{F} is unknown, ΔT_{F} is also unknown, and therefore the body temperature of the animal cannot be determined solely from the heat loss to ambient.

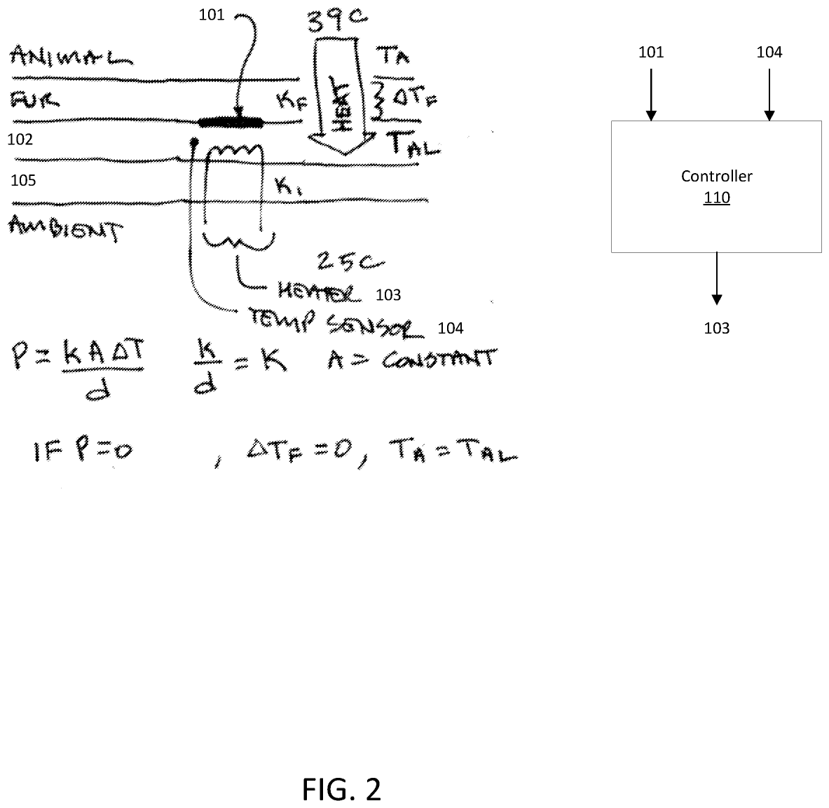

FIG. 2 is a schematic diagram showing a body temperature monitoring system in accordance with one embodiment. With reference to the baseline arrangement shown in FIG. 1, the system of FIG. 2 adds a heat conducting layer 102 (e.g., a metal such as aluminum or copper, graphene, diamond, or other appropriate thermal conductor material) above an insulation layer 105 (e.g., air, foam, fiberglass, or other insulation material) and places a heat flux sensor 101 (e.g., Peltier device or other appropriate transducer that converts heat differential to signals such as voltage signals, current signals, digital signals, etc.) above the heat conducting layer 102 such that the signals output by the heat flux sensor 101 are representative of a temperature differential between the heat conducting layer 102 and the animal or other subject atop the heat flux sensor 101, which may be in direct or indirect contact with the heat flux sensor 101. Thus, for example, when no animal is present atop the heat flux sensor 101, the temperature above the heat flux sensor 101 nominally will be the same as the temperature of the heat conducting layer 102, and therefore the signals output by the heat flux sensor 101 should indicate a zero temperature difference (e.g., a zero voltage or zero current signal, or a digital signal indicating zero temperature difference). However, when an animal is present atop the heat flux sensor 101, the temperature above the heat flux sensor 101 should be greater than the temperature of the heat conducting layer 102 (assuming the ambient temperature is below the animal temperature), and therefore the signals output by the heat flux sensor 101 should indicate a non-zero temperature differential (e.g., a temperature differential greater than zero). A heater 103 is used to heat the heat conducting layer 102 under the control of a process controller 110 until the temperature of the heat conducting layer 102 is substantially equal to the animal temperature, i.e., until the signals output by the heat flux sensor 101 indicate a temperature differential of zero. At that point, the temperature of the heat conducting layer 102 is substantially equal to the animal temperature. The temperature of the heat conducting layer 102 is then measured by a temperature sensor 104 to obtain an estimate of the animal temperature.

Thus, for example, the process controller 110 generally includes an input coupled to the output of the heat flux sensor 101 for obtaining the signals from the heat flux sensor 101, a heater output for controlling the heater 103 based on the signals from the heat flux sensor 101, and a temperature sensor input coupled to the temperature sensor 104 for obtaining temperature readings to determine the animal temperature, in which heat flow (as represented by the signals output from the heat flux sensor 101) is used as a feedback error signal to control the heater 103 and temperature sensing 104 functions. The Peltier device measures heat flow (voltage α ΔTₚ), and the process controller 110 can control the heater 103 to minimize the Peltier output voltage. When the Peltier output voltage is zero, this indicates that heat flow is zero such that the temperature of the heat conducting layer 102 is equal to the temperature of the animal or other subject. The insulation layer 105 about the heat conducting layer 102 affects the measurement speed but not necessarily measurement accuracy as it acts in opposition to the heater. The heater adds heat. The insulation allows heat to dissipate. The insulation layer 105 is discussed further below.

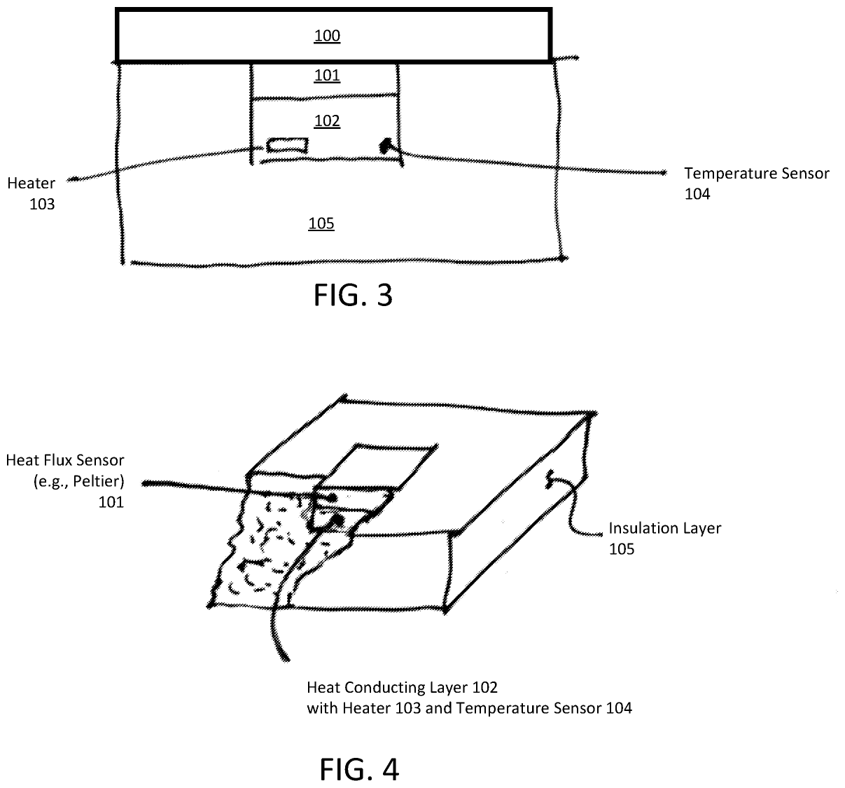

FIG. 3 is a schematic side cross-sectional view of a temperature monitoring system in accordance with one embodiment, and FIG. 4 is a schematic perspective cut-away view of the temperature monitoring system of FIG. 3. In this embodiment, the temperature monitoring system includes the insulation layer 105 surrounding the heat conducting layer 102 (sometimes referred to herein as lower heat spreader 102) with heater 103 and temperature sensor 104 and heat flux sensor 101. The temperature monitoring system can be provided in any of a variety of form factors (e.g., a bed or a pad on which a subject such as an animal or human can lie and have its temperature monitored non-invasively over a period of time including when resting, asleep, sedated, or unconscious). The heat flux sensor 101 may be exposed on the top layer although alternative embodiments could include an optional heat conducting layer 100 over the heat flux sensor 101 (sometimes referred to herein as the heat spreader 100, which additionally may act as a cushion such as for comfort or stability of the subject).

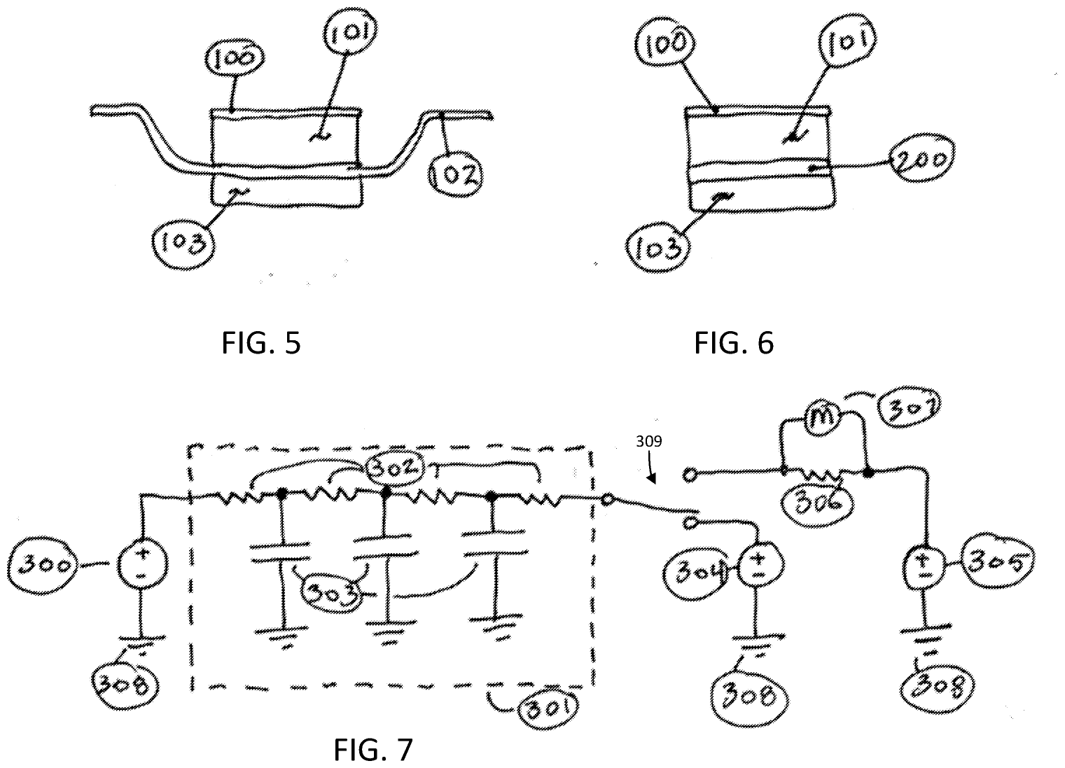

FIG. 5 is a cross-sectional view of a rotationally symmetric arrangement of components in accordance with one alternative embodiment. Part 100 is a thermally conductive material used to distribute any temperature gradients (sometimes referred to herein as heat spreader or heat conducting layer 100). Part 101 is a heat flux sensor—in this embodiment a Peltier thermoelectric device was employed in this capacity. Part 102 is a lower heat spreader made of a thermally conductive material. Part 103 is a controllable source of heat, e.g., a resistor or FET.

An object and insulation are brought into contact with the heat spreader (100). The physical thickness of the insulation should, ideally, be less than the compass of the head spreader 100. As heat begins to flow through the insulator, the heat flux sensor (101) begins to register this flow of heat and produce a voltage in proportion. This voltage is used as an input to the controller 110 (e.g., a PID control system) which then regulates the heat produced by the heater (103). The heat produced is controlled to drive the signal from the heat flux sensor (101) (e.g., the error signal) to zero.

Effectively, controlling the heater 103 in this manner causes the sensor 101 to act as a theoretically perfect insulator. Once equilibrium is reached, the temperature of the heat spreader (100), the lower heat spreader (102), the heater (103), and the heat flux sensor (101) are equal to the temperature of the object being sensed through the insulation. A measurement of temperature of the heat spreader (100) or heater (103) return an accurate temperature measurement of the object being sensed.

In this embodiment, the lower heat spreader (102) presents a circumferential ring (e.g., shaped like a bowl or ring) to the object being measured. This ring acts in a way analogous to the guard ring often used in circuit board design when small currents are of interest, i.e., it provides a degree of protection against heat which might flow laterally into or out from the region of the measurement.

FIG. 6 shows another alternative embodiment in which the lower heat spreader (102) is a thermal mass (200). This thermal mass (200) essentially serves the same purpose, i.e., diffusing heat gradients which may exist across the sensor. In this embodiment, the thermal mass 200 does not include the guard ring. This configuration may be useful, for example, when thinner insulation layers (e.g., much less than the compass of the heat spreader (100)) are of interest.

FIG. 7 is a schematic circuit diagram for the embodiments described above. This circuit diagram is a simplified electrical analog of the thermal path through the sensor 101. The potential source (300) represents the temperature of the object being sensed relative to absolute zero or ground potential (308). The potential source (304) represents the ambient temperature relative to absolute zero or ground potential (308). The potential source (305) represents the heater (103) mentioned earlier, again, referenced to absolute zero or ground potential (308).

The heat flux sensor 101 is represented by a resistor (306) and a meter (307). Thus, current flow through the resistor (306) creates a voltage difference which can be measured by a meter (307).

An optional single pole dual throw (SPDT) switch (309) allows for simulating the moment the insulator and sensor are brought into contact, which may be of special interest in some applications.

The portion of the circuit labeled 301 is a lumped model of the thermal conductivity (resistors, 302) and thermal mass (capacitors, 303) of the insulator. This circuit will be recognized as an RC low-pass filter.

When the object to be measured is at equilibrium with the environment—switch (309) as shown—the current flow through the resistors (302) and voltages across the capacitors (303) are constant, unchanging. The cascade of thermal potentials (voltages) across each resistor in the low-pass filter is a useful representation of the temperature gradient across the insulator.

When, suddenly, the insulated object being measured is brought into contact with the sensor—represented in this model by moving the switch (304) to the upper position—any difference between the equilibrium temperature on the outside of the insulator and the sensor causes heat to flow. This flow of heat—modeled as a current—causes a voltage across the sense resistor (306). This signal is used to control the potential source (305) which represents the heater (e.g., via a PID controller) to drive the sense resistor (306) voltage to zero.

As can be understood, some time is required to bring the heater—represented by potential source 305—into equilibrium with the temperature of interest—represented by the potential source (300). The time required is set by the allowable measurement error and the properties of the insulator (as represented by the low-pass filter circuit 301).

If the approximate temperature of interest (potential source 300) is known a-priori, and a likely range of insulator properties are known, an additional control rule can be invoked. This additional control rule would hold the heater—potential (305)—at the expected measurement temperature (e.g., average body temperature) upon, and for some time after, contact with the insulated object of interest. After this predetermined time (e.g., determined by the likely insulator properties), the former PID control rule is invoked. This additional control rule can thereby reduce the time required for the system to reach equilibrium (e.g., by approximately half).

It should be noted that heater (103) is for detecting or monitoring temperatures above ambient. If the ambient temperature is higher than the subject temperature, then the system may not operate as required because heat would not flow from the subject being measured (e.g., animal or human body) to the heat conducting layer. Therefore, alternative embodiments could include a cooling device or a device capable of both heating and cooling (e.g., another Peltier device) in addition to or in place of the heater (103) in order to produce a sufficient temperature differential. Thus, for example, embodiments can include a temperature controller having a heater and/or a cooler, depending on the ambient and animal temperature ranges of interest. The present invention is not limited to any particular type of heater and/or cooler. Cooling generally operates in a similar manner to heating, e.g., controlling the cooler to cool the heat conducting layer until the heat flux sensor produces signals indicating a temperature differential of zero.

It should be noted that the insulation layer 105 can be considered optional in some embodiments. Generally speaking, the role of the insulation layer 105 is to control or match the rate at which heat enters and leaves the heat conducting layer 102, e.g., the rate at which heat is added to the heat conducting layer 102 via the heater 103 versus the rate at which heat is lost to ambient via the insulation layer 105. In essence, heater power (wattage) sets the rate at which the temperature can increase, while insulation properties and temperature difference sets the rate at which temperature can decrease. When the heater 103 is replaced by a Peltier device or other device that can force heat in either direction, the insulation becomes less important. Furthermore, in some embodiments, air and/or other components (e.g., a product housing) can provide thermal insulation in lieu of an additional separate insulation layer.

It should be noted that temperature monitoring systems of the types described herein can be used in a wide range of applications and particularly applications in which temperature needs to be monitored through an intervening insulation layer such as animal fur, animal shell, a blanket, a bandage or cast, clothing, etc. As mentioned above, the solutions can be useful in medical treatments but similarly could be useful in other areas such as, without limitation, semiconductors, measuring internal temperature of a compost heap, etc. The solutions could be used for hypothermia and hyperthermia detection. The solutions could be used to measure temperature without disturbing the environment of the subject such as, without limitation, monitoring temperature of a patient who is in an intensive care unit, oxygen tent, quarantine, etc. The solutions can be particularly useful for monitoring temperature of large or dangerous animals such as, without limitation, lions, tigers, elephants, giraffes, etc.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In alternative embodiments, the disclosed apparatus and methods (e.g., as in any flow charts or logic flows described above) may be implemented as a computer program product for use with a computer system. Such implementation may include a series of computer instructions fixed on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as a tangible, non-transitory semiconductor, magnetic, optical or other memory device, and may be transmitted using any communications technology, such as optical, infrared, RF/microwave, or other transmission technologies over any appropriate medium, e.g., wired (e.g., wire, coaxial cable, fiber optic cable, etc.) or wireless (e.g., through air or space).

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the described controller) are necessarily non-conventional because, absent special programming or configuration, the conventional components do not inherently perform the described non-conventional functions.

The activities described and claimed herein provide technological solutions to problems that arise squarely in the realm of technology. These solutions as a whole are not well-understood, routine, or conventional and in any case provide practical applications that transform and improve computers and computer routing systems.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A system for monitoring temperature of a subject, the system comprising:
a heat conducting layer;
a heat flux sensor positioned to be between the heat conducting layer and the subject when the subject is placed directly or indirectly in contact with the heat flux sensor, the heat flux sensor configured to provide signals representative of a temperature difference between the heat conducting layer and the subject;
a temperature controller to affect the temperature of the heat conducting layer;
a temperature sensor to sense temperature of the heat conducting layer; and
a process controller coupled to the temperature controller, the temperature sensor, and the heat flux sensor, wherein the process controller is configured to control the temperature controller based on the signals to affect the temperature of the heat conducting layer until the signals indicate that the temperature of the heat conducting layer is substantially equal to the temperature of the subject and then to determine the temperature of the heat conducting layer using the temperature sensor.

2. The system of claim 1, wherein the heat flux sensor includes a Peltier device.

3. The system of claim 1, wherein the temperature controller includes a heater.

4. The system of claim 3, wherein the heater includes a resistor or a FET.

5. The system of claim 1, wherein the temperature controller includes a cooler.

6. The system of claim 1, wherein the temperature controller includes a Peltier device that can alternatively heat or cool the heat conducting layer.

7. The system of claim 1, wherein the heat conducting layer includes a metal.

8. The system of claim 1, wherein the heat conducting layer is configured to protect against heat flowing laterally into or out from a measurement region about the heat flux sensor.

9. The system of claim 8, wherein the heat conducting layer is configured as a bowl or ring.

10. The system of claim 1, wherein the heat conducting layer is a thermal mass configured to diffuse heat gradients across the heat flux sensor.

11. The system of claim 1, wherein the signals are voltage signals.

12. The system of claim 1, wherein the signals are current signals.

13. The system of claim 1, wherein the signals are digital signals.

14. The system of claim 1, wherein the process controller includes a PID controller.

15. The system of claim 1, wherein the process controller is configured to control the temperature of the heat conducting layer to a predetermined temperature before the subject is placed directly or indirectly in contact with the heat flux sensor.

16. The system of claim 1, wherein the subject is placed in direct contact with the heat flux sensor.

17. The system of claim 1, further comprising an insulating layer that thermally insulates at least a portion of the heat conducting layer.

18. The system of claim 17, wherein the insulating layer comprises air.

19. The system of claim 1, further comprising a heat spreader positioned to be between the heat flux sensor and the subject.

20. The system of claim 19, wherein the heat spreader includes a cushion.

21. The system of claim 1, wherein the components are incorporated in a device on which the subject can rest.

22. The system of claim 21, wherein the device is a pet bed.

23. The system of claim 21, wherein the device is a pad.

24. The system of claim 1, wherein the subject is an animal.

25. The system of claim 1, wherein the subject is a human.
